(19) United States
(12) Patent Application Publication
(10) Pub. No.: US 2018/0004697 A1
(43) Pub. Date: Jan. 4, 2018

(54) CONTROL SYSTEM AND CONTROL METHOD THEREOF

(71) Applicants: INVENTEC (PUDONG) TECHNOLOGY CORPORATION, Shanghai City (CN); INVENTEC CORPORATION, Taipei City (TW)

(72) Inventors: Li-Hong HUANG, Shanghai City (CN); Jiang-Tao YUAN, Shanghai City (CN)

(73) Assignees: INVENTEC (PUDONG) TECHNOLOGY CORPORATION, Shanghai City (CN); INVENTEC CORPORATION, Taipei City (TW)

(21) Appl. No.: 15/273,603

(22) Filed: Sep. 22, 2016

(30) Foreign Application Priority Data
Jul. 4, 2016 (CN) 201610517149.6

(51) Int. Cl. G06F 13/40; G06F 13/42

(52) U.S. Cl. CPC G06F 13/4068; G06F 13/4282

(57) ABSTRACT

A control system includes a first expander board and a second expander board. The first expander board selects a first data segment from a first data signal according to a first clock signal. The second expander board is electrically connected to the first expander board. The second expander board is configured to receive the first data segment and the first clock signal of the first expander board. The second expander board selects a second data segment from a second data signal according to a second clock signal and sequentially outputs the first data segment and the second data segment. The sequentially output form of the first data segment and the second data segment from the second expander board is a serial data signal.

### CROSS-REFERENCE TO RELATED APPLICATIONS

This non-provisional application claims priority under 35 U.S.C. §119(a) on Patent Application No(s). 201610517149.6 filed in China, on Jul. 4, 2016, the entire contents of which are hereby incorporated by reference.

### TECHNICAL FIELD

The disclosure relates to a control system and a control method thereof, more particularly to a control system and a control method thereof for serially connecting a plurality of data segments as a serial data signal.

### BACKGROUND

General speaking, a hardware structure of a computer may include a plurality of expander boards. Each expander board is connected to a hardware backplane through their individual signal transmission line so that data of each expander board is sent to the corresponding hardware through the hardware backplane. For example, when a hardware structure of a computer includes six expander boards, a backplane must reserve six sets of signal lines to the six expander boards for sending their individual data signal. In other words, more signal lines must be reserved by the hardware backplane when more expander boards are included in the hardware structure of the computer. Therefore, the number of signal transmission lines of the hardware back plane would be occupied and the circuit would become more complicated.

### SUMMARY

According to one embodiment of the present disclosure, a control system includes a first expander board and a second expander board. The first expander board is configured to select a first data segment from a first data signal according to a first clock signal, and the second expander board is coupled to the first expander board and configured to receive the first data segment and the first clock signal, and select a second data segment from a second data signal according to a second clock signal and sequentially output the first data segment and the second data segment. The sequentially output form of the first data segment and the second data segment from the second expander board is a serial data signal. In one embodiment, the first data segment is in a first time interval, and the second data segment is in a second time interval. The second expander board outputs the first data segment in the first time interval and outputs the second data segment in the second time interval.

In another embodiment, the first data segment includes a first identification code, and the second data segment includes a second identification code. In another embodiment, the control system further includes a first hardware component, second hardware component and a processor. The first hardware component corresponds to the first identification code. The second hardware component corresponds to the second identification code. The processor is coupled to the second expander board, the first hardware component and the second hardware component and configured to process the serial data signal. The processor generates a first control signal according to the first data segment and the first identification code and sends the first control signal to the first hardware component. The processor generate a second control signal according to the second data segment and the second identification code and sends the second control signal to the second hardware component. In other embodiment, the first hardware component has a first status light indicating a status of the first hardware component according to the first control signal, and the second hardware component has a second status light indicating a status of the second hardware component according to the second control signal.

In one embodiment, the first expander board has a first loading signal configured to indicate a plurality of initial points of the first data segment, a data signal before a first initial point among the initial points of the first data segment is different from a data signal after the first initial point, the second expander board has a second loading signal configured to indicate a plurality of initial points of the second data segment, a data signal before a second initial point among the initial points of the second data segment is different from a data signal after the second initial point.

According to another embodiment of the present disclosure, a control method includes the following steps. Select a first data segment from a first data signal according to a first clock signal. Select a second data segment from a second data signal according to a second clock signal. Sequentially output the first data segment and the second data segment, wherein sequentially output form of the first data segment and the second data segment is a serial data signal. In one embodiment, the first data segment is in a first time interval, the second data segment is in a second time interval, the second expander board outputs the first data segment in the first time interval and outputs the second data segment in the second time interval.

In another embodiment, the control method further includes the following steps. Process the serial data signal and generate a first control signal according to the first data segment and a first identification code of the first data segment and send the first control signal to a first hardware component, wherein the first hardware component corresponds to the first identification code. Generate a second control signal according to the second data segment and a second identification code of the second data segment and send the second control signal to a second hardware component, wherein the second hardware component corresponds to the second identification code. In another embodiment, the first hardware component has a first status light indicating a status of the first hardware component according to the first control signal, and the second hardware component has a second status light indicating a status of the second hardware component according to the second control signal.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is a schematic diagram of a control system in one embodiment;

FIG. 2 is a block diagram of the control system in one embodiment;

FIG. 3A is a schematic diagram of a first clock signal and a first data signal in one embodiment;

FIG. 3B is a schematic diagram of a second clock signal and a second data signal in one embodiment;

FIG. 3C is a schematic diagram of a serial signal in one embodiment;

FIG. 3D is a schematic diagram illustrating the first data segment, the second data segment, the first loading signal and the second loading signal in one embodiment; and

FIG. 4 is a flow chart of a control method in one embodiment.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

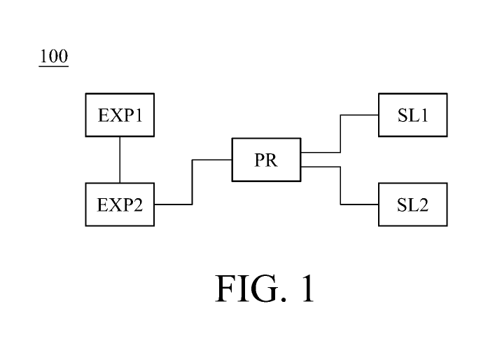

Please refer to FIG. 1. FIG. 1 is a schematic diagram of a control system in one embodiment. As shown in FIG. 1, the control system 100 includes a first expander board EXP1, a second expander board EXP2, a processor PR, a first status light SL1 and a second status light SL2. The second expander board EXP2 is coupled to the first expander board EXP1 and the processor PR. The second expander board EXP2 is configured to serially connect its own data signal and the data signal of the first expander board EXP1 as a serial data signal and then send the serial data signal to the processor PR. In practical, both the first expander board EXP1 and the second expander board EXP2 are interfaces for connecting electrical components to other devices. In one embodiment, the second expander board EXP2 is coupled to a plurality of expander boards. For example, assume the second expander board EXP2 is coupled to two expander boards. The second expander board EXP2 serially connects its own signal and signals of the two expander boards as a serial data signal and sends the serial data signal to the processor PR. The processor PR is coupled to the first status light SL1 and the second status light SL2. The processor PR is configured to process the serial data signal and send the processing result to the first status light SL1 and the second status light SL2. For example, the processor PR is a complex programmable logic device (CPLD), a field programmable gate array (FPGA) or other equivalent component. The present disclosure is not limited to the embodiments mentioned above. Both the first status light SL1 and the second status light SL2 indicate the operating status of individual hardware component according to a control signal generated by processing the serial signal. In practice, the processor PR could be coupled to more than two status lights.

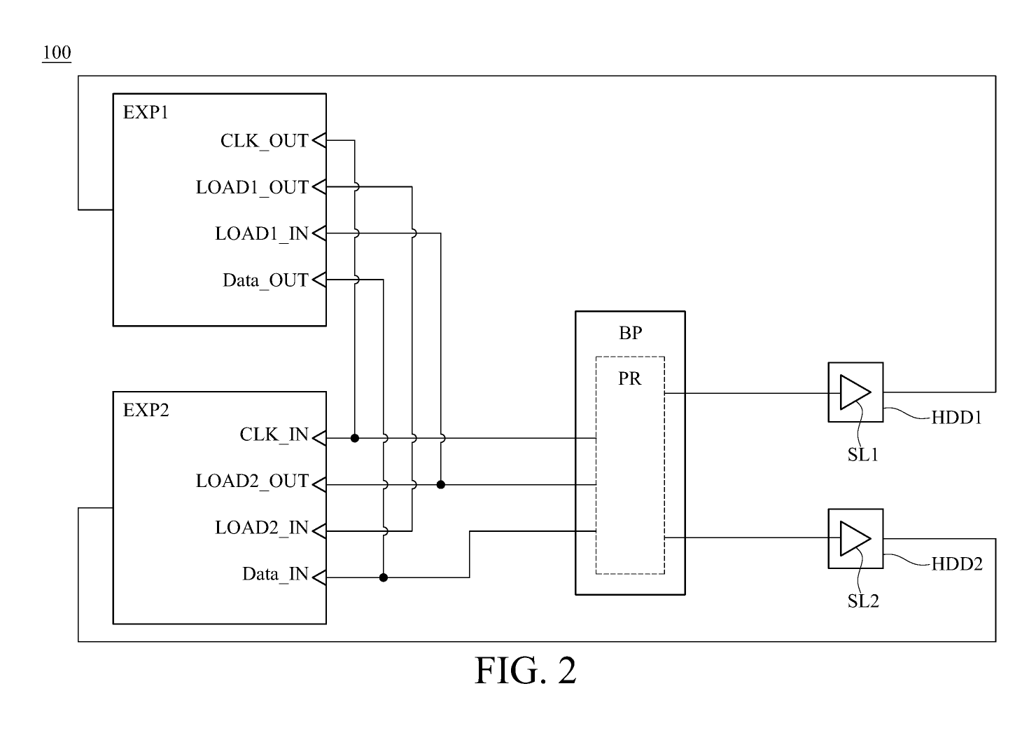

Please refer to FIG. 2. FIG. 2 is a block diagram of a control system in one embodiment. As shown in FIG. 2, the first hardware component HDD1 and the second hardware component HDD2 are respectively connected to the first expander board EXP1 and the second expander board EXP2. The clock output terminal CLK_OUT of the first expander board EXP1 is electrically connected to the clock input terminal CLK_IN of the second expander board EXP2. The first loading signal output terminal LOAD1_OUT of the first expander board EXP1 is electrically connected to the second loading signal input terminal LOAD2_IN of the second expander board EXP2. The signal output terminal Data_out of the first expander board EXP1 is electrically connected to the signal input terminal Data_IN of the second expander board EXP2.

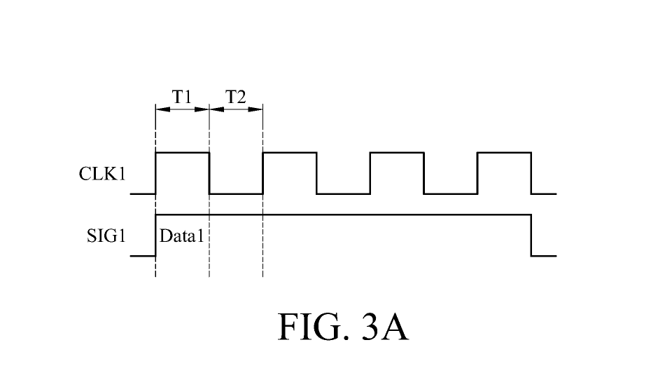

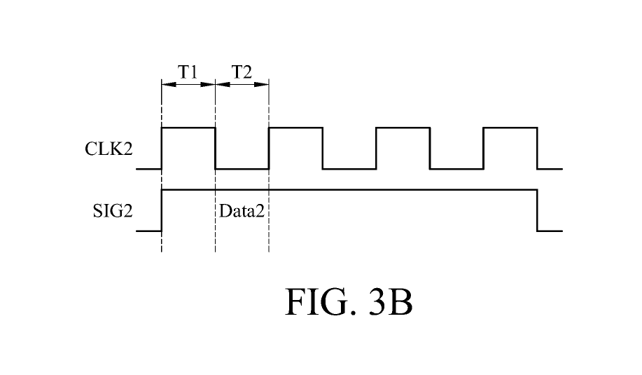

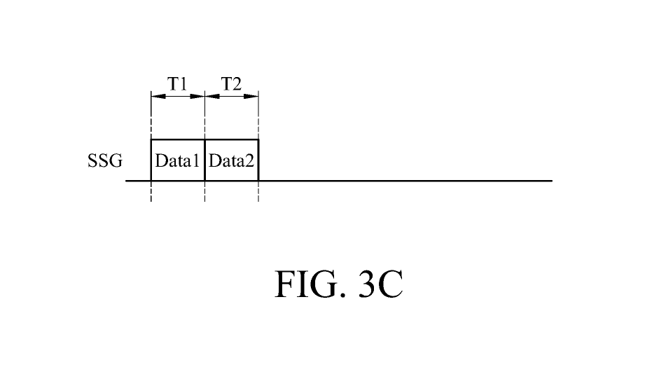

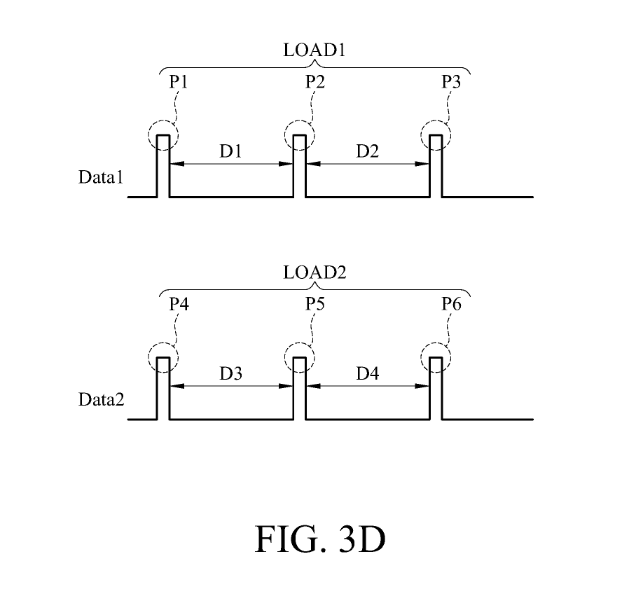

Please refer to FIG. 2, FIG. 3A and FIG. 3B. FIG. 3A is a schematic diagram of a first clock signal and a first data signal in one embodiment. FIG. 3B is a schematic diagram of a second clock signal and a second data signal in one embodiment. The first expander board EXP1 and the second expander board EXP2 respectively receive the first data signal SIG1 of the first hardware component HDD1 and the second data signal SIG2 of the second hardware component HDD2. As shown in FIG. 3A, the first expander board EXP1 selects a first data segment Data1 from the first data signal SIG1 according to the first clock signal CLK1. The first expander board EXP1 sends the first data segment Data1 to the second expander board EXP2 through the signal output terminal Data_out. In one embodiment, both the first data signal SIG1 and the second data signal SIG2 include data related to the operating statuses of common computer hardware components. In some embodiments, both the first clock signal CLK1 and the second clock signal CLK2 have the same period so that the timing of the first expander board EXP1 could correspond to the timing of the second expander board EXP2. Therefore, the first expander board EXP1 and the second expander board EXP2 select their individual signal easily. Nevertheless, in some other embodiments, the period of the first expander board EXP1 is different from the period of the second expander board EXP2. The present disclosure is not limited to the above embodiments.

The second expander board EXP2 receives the first data segment Data1 through the signal input terminal Data_IN. As shown in FIG. 3B, the second expander board EXP2 selects the second data segment Data2 from the second data signal SIG2. Please refer to FIG. 3C. FIG. 3C is a schematic diagram of a serial signal in one embodiment. As shown in FIG. 3C, the second expander board EXP2 sequentially outputs the first data segment Data1 and the second data segment Data2. The sequentially output form of the first data segment Data1 and the second data segment Data2 is a serial signal SSG. In one embodiment, as shown in FIG. 3C, the first data segment Data1 and the second data segment data2 are respectively in the first time interval T1 and the second time interval T2. The second expander board EXP2 outputs the first data segment Data1 in the first time interval T1 and outputs the second data segment data2 in the second time interval T2. The first time interval T1 is adjacent to the second time interval T2.

The first expander board EXP1 has a first loading signal LOAD1 configured to indicate a plurality of initial points of the first data segment Data1. A data signal before a first initial point among the initial points of the first data segment is different from a data signal after the first initial point. The second expander board Exp2 has a second loading signal LOAD2 configured to indicate a plurality of initial points of the second data segment Data2. A data signal before a second initial point among the initial points of the second data segment is different from a data signal after the second initial point. In practical, both the first data segment Data1 and the second data segment Data2 have different data signals of hardware components such as data signals of normal operations of the hardware components or data signals of abnormal operations of the hardware components.

Please refer to FIG. 3D. FIG. 3D is a schematic diagram illustrating the first data segment, the second data segment, the first loading signal and the second loading signal in one embodiment. As shown in FIG. 3D, the first loading signal LOAD1 and the second loading signal LOAD2 respectively indicate a plurality of initial points of the first data segment Data1 and the second data segment Data2, and divide both the first data segment Data1 and the second data segment Data2 into different data signals within their low level statuses through their individual high level statuses.

For example, as shown in FIG. 3D, the first loading signal LOAD1 indicates three initial points P1, P2 and P3 in the first data segment Data1 and divides the first data segment Data1 into different data signals through the initial points P1, P2 and P3. The data signal D1 in the first time interval (between the initial point P1 and the initial point P2) is different from the data signal D2 in the second time interval (between the initial point P2 and the initial point P3). In other words, the data signal before the initial point P2 is different from the data signal after the initial point P2. Similarly, the second loading signal LOAD2 indicates three initial points P4, P5 and P6 in the second data segment Data2 and divides the second data segment Data2 into different data signal through the initial points P4, P5 and P6. The data signal D3 in the first time interval (between the initial point P4 and the initial point P5) is different from the data signal D4 in the second time interval (between the initial points P5 and the initial points P6). In other words, the data signal before the initial point P5 is different from the data signal after the initial point P5. When the data signal D1, D2, D3 and D4 are respectively sent to status lights of corresponding hardware components, the status lights will indicate the statuses of the hardware components.

In one embodiment, in order to reach the synchronization of the signal transmission between the first expander board EXP1 and the second expander board EXP2, the first expander board EXP1 sends the first clock signal CLK1 to the second expander board EXP2 through the clock output terminal CLK_OUT. The first expander board EXP1 sends the first loading signal LOAD1 to the second loading signal input terminal LOAD2_IN of the second expander board EXP2 through the first loading signal output terminal LOAD1_OUT. The second expander board EXP2 sends the second loading signal LOAD2 to the first loading signal input terminal LOAD1_IN of the first expander board EXP1 through the second loading signal output terminal LOAD2_OUT.

The processor PR is disposed within the backplane BP, and one end of the processor PR is electrically connected to the second expander board EXP2 for processing the data signal SSG. In one embodiment, the backplane BP is an entity bus having a plurality of connectors for connecting circuit boards. The processor PR generates the first control signal CTL1 according to the first data segment Data1 and the first identification code N1 of the first data segment Data1, and sends the first control signal CTL1 to the first hardware component HDD1. The processor PR generates the second control signal CTL2 according to the second data segment Data2 and the second identification code N2 of the second data segment Data2, and sends the second control signal CTL2 to the second hardware component HDD2.

The other end of the processor PR is electrically connected to both the status light SL1 of the first hardware component HDD1 and the second status light SL2 of the second hardware component HDD2. In one embodiment, the first status light SL1 and the second status light SL2 are common light-emitting diodes (LED). The first status light SL1 and the second status light SL2 operate with different blinking rates and colors. However, the present disclosure is not limited to the above embodiment. The first status light SL1 indicates the status of the first hardware component according to the first control signal CTL1. The second status light SL2 indicates the status of the second hardware component according to the second control signal CTL2. In one embodiment, the first status light SL1 and the second status light SL2 notify the user of the current statuses of the hardware components through different light indicating ways. For example, when the status light indicates the status of the hardware component with a solid green light, it represents that the hardware component operates normally. When the status light indicates the status of the hardware component with a blinking red light, it represents that the hardware component operates abnormally. The indicating ways of the status lights mentioned above are just for illustrating, and the present disclosure is not limited to the above embodiments.

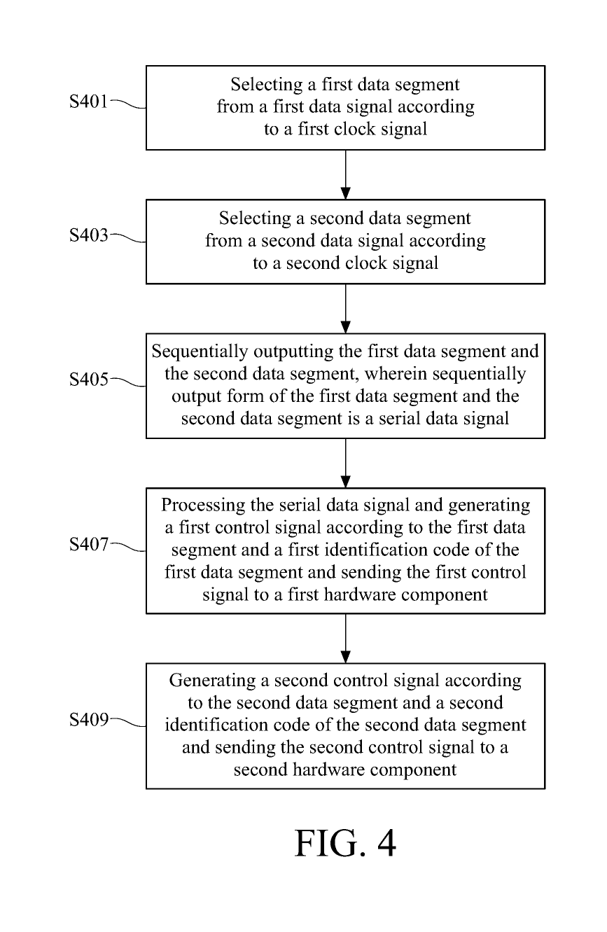

Please refer to FIG. 2, FIG. 3A-3C and FIG. 4. FIG. 4 is a flow chart of a control method in one embodiment. The control method is adapted for the control system 100 in FIG. 2. When the first expander board EXP1 and the second expander board EXP2 in the control system 100 respectively receive the first data signal SIG1 of the first hardware component HDD1 and the second data signal SIG2 of the second hardware component HDD2, in step S401, the first expander board EXP1 would select the first data segment Data1 from the first data signal according to the first clock signal CLK1. In one embodiment, the first clock signal CLK1 has a high level status and a low level status, and the first expander board EXP1 selects the first data segment Data1 according to the high level status or the low level status of the first clock signal CLK1. For example, as shown in FIG. 3A, when the first clock signal CLK1 is in the high level status, the first expander board EXP1 would select a data segment as the first data segment Data1. In another embodiment, when the first clock signal CLK1 is in the low level status, the first expander board EXP1 would select a data segment as the first data segment Data1. In some embodiments, the first data signal SIG1 is a continuous signal including a plurality of data segments.

The first expander board EXP1 sends the first data segment Data1 to the second expander board EXP2 after selecting the first data segment Data1. In step S403, the second expander board EXP2 selects the second data segment Data2 from the second data signal SIG2 according to a high level status or a low level status of the second clock signal CLK2. For example, as shown in FIG. 3B, the second expander board EXP2 selects the second data segment Data2 according to the low level status of the second clock signal CLK2. In one embodiment, the first expander board EXP1 and the second expander board EXP2 select their individual data segments concurrently. In other embodiment, the second expander board EXP2 selects the second data segment Data2 first, and then the first expander board EXP1 selects the first data segment Data1.

In the following step S405, the second expander board EXP2 sequentially output the first data segment Data1 and the second data segment Data2. In one embodiment, as shown in FIG. 3C, the selected first data segment Data1 is in the first time interval T1, and the selected second data segment Data2 is in the second time interval T2. The second expander board EXP2 outputs the first data segment Data1 within the first time interval T1 and outputs the second data segment Data2 within the second time interval T2 through a single transmission line. The sequentially output form of the first data segment Data1 and the second data segment Data2 from the second expander board EXP2 is the serial data signal SSG. In other words, the data of the first data segment Data1 and the second data segment Data2 is sent as the serial signal SSG to the processor PR in the backplane BP through the second expander board EXP2.

More specifically, assume the first data segment Data1 includes 30 bits data, and the second data segment Data2 also includes 30 bits data. Through the control system 100 and its the control method, both the 30 bits data of the first data segment Data1 and the 30 bits data of the second data segment Data2 could be sent out through the transmission line between the signal input terminal Data_IN of the second expander board EXP2 and the processor PR in the backplane BP. In the other words, total 60 bits data could be delivered through the transmission line. The 60 bits data is included in the data signal SSG. In practical, the first expander board EXP1 and the second expander board EXP2 could select more data segments in time intervals (e.g., a third time interval and a fourth time interval) after the first time interval T1 and the second time interval T2. The second expander board EXP2 could sequentially output more data segments.

After the serial data signal SSG is output to the processor PR through the second expander board EXP2, in step S407, the processor PR processes the serial data signal SSG. In one embodiment, the processor PR is a chip of a digital circuit consisting of a plurality of logic gates. The processor PR such as a complex programmable logic device (CPLD) or a field programmable gate array (FPGA) could process for programmable configurations and decoding through the circuit consisting of the logic gates. However, the present disclosure is not limited to the above embodiment. The processor PR could decode the data signal SSG including the first data segment Data1 and the second data segment Data2 into the first data segment Data1 and the second data segment Data2.

In one embodiment, in step S407, the processor PR generates a first control signal CTL1 according to the first data segment Data1 and the first identification code N1 of the first data segment Data1, and sends the first control signal CTL1 to the first hardware component HDD1. In one embodiment, the first data segment Data1 includes not only its own data but also a header for identification. The header includes the identification code corresponding to its own hardware component. The processor PR would recognize one of the hardware components corresponding to the first data segment Data1 through the identification code. For example, in one embodiment, the header of the first data segment Data1 includes the first identification code N1. The first identification code N1 corresponds to the first hardware component HDD1. Therefore, as the processor PR recognizes the first identification code N1 from the header of the first data segment Data1, it would recognizes that the first data segment Data1 corresponds to the first hardware component HDD1 through the first identification code N1. Then the processor PR generates the first control signal CTL1 according to the identification code N1 and the first data segment Data1, and sends the first control signal CTL1 to the first hardware component HDD1.

Based on the same reason, in step S409, the processor PR generates the second control signal CTL2 according to the second data segment Data2 and the second identification code N2 of the second data segment Data2 and sends the second the control signal CTL2 to the second hardware component HDD2. In one embodiment, the processor PR recognizes the second identification code N2 from the header of the second data segment Data2. The second identification code N2 corresponds to the second hardware component HDD2. Therefore, the processor PR sends the second control signal CTL2 to the second hardware component HDD2. In one embodiment, the bit number of the main data of the data segment (e.g., 60 bits) is more than the bit number of the header for identification (e.g., 3 bits). However, the present disclosure is not limited to the bit number mentioned above.

When the first hardware component HDD1 and the second hardware component HDD2 respectively receive the first control signal CTL1 and the second control signal CTL2, the first status light SL1 in the first hardware component HDD1 indicates the operating status of the hardware component HDD1 according to the first control signal CTL1, and the second status light SL2 in the second hardware component HDD2 indicates the operating status of the hardware component HDD2 according to the first control signal CTL2. For example, assume the first data segment Data1 includes 60 bits data, and the content of the 60 bits data states that the hardware component operates abnormally. When the processor PR generates the first control signal CTL1 according to the 60 bits of the first data segment Data1, the first control signal CTL1 would includes the content of the 60 bits data. Therefore, when the first status light SL1 indicates the operation of the hardware component according to first control signal CTL1, it will display a blinking red light (assume the blinking red light represents the abnormal operation of the hardware component) so that the user will be notified of the abnormal operation of the first hardware component HDD1. Then the user could take further actions for the first hardware component HDD1.

Based on the description above, in the operation of the control system and the control method, data signals of a plurality of expander boards could be connected as a serial data signal. Then the serial data signal will be sent to the processor in the backplane by one of the expander boards through a single transmission line. Therefore, the number of transmission line between the expander boards and the backplane could be decreased so that the complexity of the circuit is deceased.

What is claimed is:

1. A control system, comprising:
a first expender board configured to select a first data segment from a first data signal according to a first clock signal; and
a second expender board coupled to the first expender board and configured to receive the first data segment and the first clock signal and select a second data segment from a second data signal according to a second clock signal and sequentially output the first data segment and the second data segment;
wherein sequentially output form of the first data segment and the second data segment from the second expender board is a serial data signal.

2. The control system according to claim 1, wherein the first data segment is in a first time interval, the second data segment is in a second time interval, the second expander board outputs the first data segment in the first time interval and outputs the second data segment in the second time interval.

3. The control system according to claim 1, wherein the first data segment comprises a first identification code, the second data segment comprises a second identification code.

4. The control system according to claim 3, further comprising:
a first hardware component corresponding to the first identification code;
a second hardware component corresponding to the second identification code; and
a processor coupled to the second expender board, the first hardware component and the second hardware component and configured to process the serial data signal and generate a first control signal according to the first data segment and the first identification code and send the first control signal to the first hardware component, and generate a second control signal according to the second data segment and the second identification code and send the second control signal to the second hardware component.

5. The control system according to claim 4, wherein the first hardware component has a first status light indicating a status of the first hardware component according to the first control signal, the second hardware component has a second status light indicating a status of the second hardware component according to the second control signal.

6. The control system according to claim 1, wherein the first expender board has a first loading signal configured to indicate a plurality of initial points of the first data segment, a data signal before a first initial point among the initial points of the first data segment is different from a data signal after the first initial point, the second expender board has a second loading signal configured to indicate a plurality of initial points of the second data segment, a data signal before a second initial point among the initial points of the second data segment is different from a data signal after the second initial point.

7. A control method, comprising:
selecting a first data segment from a first data signal according to a first clock signal;
selecting a second data segment from a second data signal according to a second clock signal; and
sequentially outputting the first data segment and the second data segment, wherein sequentially output form of the first data segment and the second data segment is a serial data signal.

8. The control method according to claim 7, wherein the first data segment is in a first time interval, the second data segment is in a second time interval, the second expender board outputs the first data segment in the first time interval and outputs the second data segment in the second time interval.

9. The control method according to claim 7, further comprising:
processing the serial data signal and generating a first control signal according to the first data segment and a first identification code of the first data segment and sending the first control signal to a first hardware component, wherein the first hardware component corresponds to the first identification code; and
generating a second control signal according to the second data segment and a second identification code of the second data segment and sending the second control signal to a second hardware component, wherein the second hardware component corresponds to the second identification code.

10. The control method according to claim 9, wherein the first hardware component has a first status light indicating a status of the first hardware component according to the first control signal, the second hardware component has a second status light indicating a status of the second hardware component according to the second control signal.
